(19) United States
(12) Patent Application Publication
(10) Pub. No.: US 2026/0062289 A1
(43) Pub. Date: Mar. 5, 2026

(54) HYDROGEN REFORMING SYSTEM

(71) Applicants: HYUNDAI MOTOR COMPANY, SEOUL (KR); KIA CORPORATION, SEOUL (KR)

(72) Inventor: Dong Seok Ko, Hwaseong-si (KR)

(73) Assignees: HYUNDAI MOTOR COMPANY, SEOUL (KR); KIA CORPORATION, SEOUL (KR)

(21) Appl. No.: 19/241,204

(22) Filed: Jun. 17, 2025

(30) Foreign Application Priority Data
Sep. 2, 2024 (KR) 10-2024-0118816

(51) Int. Cl. C01B 3/48; B01D 53/047; B01J 19/00; B01J 19/24; C01B 3/56

(52) U.S. Cl. CPC C01B 3/48; B01D 53/047; B01J 19/0013; B01J 19/245; C01B 3/56; B01D 2256/16; B01D 2257/504; B01J 2219/00063; B01J 2219/00087; B01J 2219/00108; B01J 2219/00157; B01J 2219/00159; B01J 2219/00164; B01J 2219/00204; C01B 2203/0233; C01B 2203/0283; C01B 2203/042; C01B 2203/0475; C01B 2203/0816; C01B 2203/0833; C01B 2203/1241; C01B 2203/1619; C01B 2203/169

(57) ABSTRACT

The present disclosure relates to a hydrogen reforming system including a reforming part configured to produce a reformed gas containing hydrogen by allowing a source gas and pure water to react with each other, a source gas supply line connected to the reforming part and configured to supply the source gas, a pure water supply line connected to the source gas supply line and configured to supply the pure water, a discharge line configured to discharge the reformed gas from the reforming part, and a heating part configured to selectively heat at least any one of the source gas and the pure water. The source gas and the pure water are to be supplied to the reforming part by using waste heat of the reformed gas discharged from the reforming part, thereby obtaining an advantageous effect of improving stability, reliability, and reforming efficiency.

### CROSS REFERENCE TO RELATED APPLICATIONS

This application claims priority to and the benefit of Korean Patent Application No. 10-2024-0118816 filed in the Korean Intellectual Property Office on Sep. 2, 2024, the entire contents of which are incorporated herein by reference.

### TECHNICAL FIELD

An embodiment of the present disclosure relates to a hydrogen reforming system, and more particularly, to a hydrogen reforming system capable of improving stability, reliability, and reforming efficiency.

### BACKGROUND

Technologies using hydrogen as an energy source have been developed in various fields because hydrogen is economical, environmentally friendly, and capable of being regenerated.

Hydrogen may be produced by fossil fuel-based methods such as steam reforming, coal gasification, water electrolysis, biomass gasification, and other thermochemical processes.

Among the methods, steam reforming is currently widely used because the steam reforming is less restricted in raw material and produces a larger amount of hydrogen in comparison with other processes (methods).

Steam reforming may extract hydrogen from a source gas through a process of desulfurizing a source gas (e.g., LNG), a process of reforming the source gas, and a pressure swing adsorption process.

More specifically, a reforming process may be performed by allowing a source gas and pure water (water) to react with each other in a reformer (endothermic reaction), and a reformed gas containing hydrogen may be produced by the reaction between the source gas and the pure water.

Meanwhile, temperatures of the source gas and the pure water to be introduced into the reformer need to be constantly maintained to ensure a stable operation of the reformer and improve reaction efficiency (efficiency of the reaction between the source gas and the pure water).

However, in the related art, when the temperature of the source gas or the pure water to be introduced into the reformer is decreased by a change in an external environment or the like (e.g., when a temperature of an inlet part of the reformer is less than 500° C.), coke occurs and surrounds a catalyst of the reformer, which causes a problem in that the activity of the catalyst decreases (a reaction area of the catalyst decreases). For this reason, there is a problem in that the reaction efficiency of the reformer, as well as the stability and reliability, deteriorate.

Therefore, recently, various studies have been conducted to uniformly maintain the temperatures of the source gas and the pure water to be introduced into the reformer of the hydrogen reforming system and ensure the stable operation of the reformer, but the study results are still insufficient.

### SUMMARY

The present disclosure has been made in an effort to provide a hydrogen reforming system capable of improving stability, reliability, and reforming efficiency.

In particular, the present disclosure has been made in an effort to uniformly maintain temperatures of a source gas and pure water to be introduced into a reformer and ensure a stable operation of the reformer.

Among other things, the present disclosure has been made in an effort to minimize a drop in temperature of the source gas or the pure water to be introduced into the reformer (minimize the occurrence of coke in the reformer) by using waste heat of a reformed gas discharged from a reforming part and stably ensure reaction efficiency of the reformer.

The present disclosure has also been made in an effort to minimize electric power consumption and improve energy efficiency.

The present disclosure has also been made in an effort to simplify a structure and improve a degree of design freedom and spatial utilization.

The objects to be achieved by the embodiments are not limited to the above-mentioned objects, but also include objects or effects that may be understood from the solutions or embodiments described below.

In order to achieve the above-mentioned objects, an exemplary embodiment of the present disclosure provides a hydrogen reforming system including: a reforming part configured to produce a reformed gas containing hydrogen by allowing a source gas and pure water to react with each other; a source gas supply line connected to the reforming part and configured to supply the source gas; a pure water supply line connected to the source gas supply line and configured to supply the pure water; a discharge line configured to discharge the reformed gas from the reforming part; and a heating part configured to selectively heat at least any one of the source gas and the pure water, which are to be supplied to the reforming part, by using waste heat of the reformed gas discharged from the reforming part.

This is to improve stability, reliability, and reforming efficiency of the hydrogen reforming system.

That is, temperatures of the source gas and the pure water to be introduced into the reformer need to be constantly maintained to ensure a stable operation of the reformer and improve reaction efficiency (efficiency of the reaction between the source gas and the pure water). However, in the related art, when the temperature of the source gas or the pure water to be introduced into the reformer is decreased by a change in an external environment or the like (e.g., when a temperature of an inlet part of the reformer is less than 500° C.), coke occurs and surrounds a catalyst of the reformer, which causes a problem in that the activity of the catalyst decreases (a reaction area of the catalyst decreases). For this reason, there is a problem in that the reaction efficiency of the reformer, as well as the stability and reliability, deteriorate.

In contrast, according to the embodiment of the present disclosure, at least any one of the source gas and the pure water, which are to be supplied to the reforming part, is selectively heated by waste heat of the reformed gas discharged from the reforming part. Therefore, it is possible to obtain an advantageous effect of minimizing a drop in temperatures of the source gas and the pure water to be introduced into the reforming part (minimizing the occurrence of coke in the reformer) and stably ensuring reaction efficiency of the reforming part.

Moreover, according to the embodiment of the present disclosure, the source gas or the pure water may be heated to a temperature appropriate for a reaction without additionally providing a separate heat source for heating the source gas or the pure water to be introduced into the reforming part. Therefore, it is possible to obtain an advantageous effect of simplifying the structure, improving the degree of design freedom and spatial utilization, minimizing the electric power consumption, and improving the energy efficiency.

The reforming part may have various structures capable of extracting hydrogen from the source gas on the basis of steam reforming.

According to the exemplary embodiment of the present disclosure, the reforming part may include: a reformer configured to produce the reformed gas containing hydrogen by allowing the source gas and the pure water to react with each other; and a water gas shift reactor configured to produce hydrogen by performing a reaction on carbon monoxide contained in the reformed gas discharged from the reformer.

According to the exemplary embodiment of the present disclosure, the hydrogen reforming system may include: a second heat exchanger provided in the discharge line while passing through the pure water supply line and configured to allow the reformed gas, which has passed through the reforming part, and the pure water, which moves along the pure water supply line, to exchange heat with each other.

The pure water supply line may have various structures capable of supplying the pure water to the reforming part.

According to the exemplary embodiment of the present disclosure, the pure water supply line may include: a first pure water supply line having a first or one end connected to a pure water supply part, and a second or the other end connected to the second heat exchanger; and a second pure water supply line having one end connected to the second heat exchanger, and the second end connected to the source gas supply line at an upstream side of the reforming part.

According to the exemplary embodiment of the present disclosure, the hydrogen reforming system may include: a third heat exchanger provided in the discharge line while passing through the second pure water supply line and configured to allow the reformed gas, which passes through the reforming part, and the pure water, which moves along the second pure water supply line, to exchange heat with each other.

According to the exemplary embodiment of the present disclosure, the hydrogen reforming system may include: an exhaust gas line along which exhaust gas heated by a burner moves; and a fourth heat exchanger provided in the source gas supply line while passing through the exhaust gas line and configured to allow the source gas, which moves along the source gas supply line, the pure water, and the exhaust gas to exchange heat with one another.

According to the exemplary embodiment of the present disclosure, the hydrogen reforming system may include: a pressure swing adsorption part provided in the discharge line and configured to separate hydrogen from the reformed gas discharged from the reforming part; and an off-gas supply line configured to connect the pressure swing adsorption part and the burner and supply an off-gas, which remains after hydrogen is separated from the reformed gas, to the burner.

As described above, in the embodiment of the present disclosure, the off-gas separated by the pressure swing adsorption part is used as the fuel for the burner. Therefore, it is possible to obtain an advantageous effect of improving energy efficiency and reducing production costs.

According to the exemplary embodiment of the present disclosure, the heating part may include: a first circulation line having one end connected to a first point on the pure water supply line, and the second end connected to a second point on the pure water supply line spaced apart from the first point, the first circulation line being configured to circulate the pure water, which has flowed from the pure water supply line, back to the pure water supply line; and a first heat exchanger provided in the first circulation line while passing through the discharge line and configured to allow the reformed gas, which is discharged from the reforming part, and the pure water, which moves along the first circulation line, to exchange heat with each other.

The first circulation line may have various structures capable of circulating the pure water, which has flowed from the pure water supply line, back to the pure water supply line.

According to the exemplary embodiment of the present disclosure, the second point may be defined at a downstream side of the first point along the pure water supply line.

According to the exemplary embodiment of the present disclosure, a first end and a second end of the first circulation line may be connected to the first pure water supply line.

According to the exemplary embodiment of the present disclosure, a first end of the first circulation line may be connected to the first pure water supply line, and the second end of the first circulation line may be connected to the second pure water supply line.

According to the exemplary embodiment of the present disclosure, the hydrogen reforming system may include: a first adjustment valve provided in the first circulation line and configured to selectively adjust a flow of the pure water moving along the first circulation line.

According to the exemplary embodiment of the present disclosure, the hydrogen reforming system may include: a temperature measurement part provided in the source gas supply line and configured to measure temperatures of the source gas and the pure water to be introduced into the reforming part, in which the first adjustment valve selectively adjusts the flow of the pure water, which moves along the first circulation line, on the basis of a signal measured by the temperature measurement part.

According to the exemplary embodiment of the present disclosure, the heating part may include: a second circulation line connected to the source gas supply line and configured to circulate the source gas, which has flowed from the source gas supply line, back to the source gas supply line; and a first heat exchanger provided in the second circulation line while passing through the discharge line and configured to allow the reformed gas, which has passed through the reforming part, and the source gas, which moves along the second circulation line, to exchange heat with each other.

According to the exemplary embodiment of the present disclosure, the hydrogen reforming system may include: a second heat exchanger provided in the discharge line while passing through the pure water supply line and configured to allow the reformed gas, which has passed through the reforming part, and the pure water, which moves along the pure water supply line, to exchange heat with each other.

According to the exemplary embodiment of the present disclosure, the pure water supply line may include: a first pure water supply line having a first end connected to a pure water supply part, and a second end connected to the second heat exchanger; and a second pure water supply line having one end connected to the second heat exchanger, and a second connected to the source gas supply line at an upstream side of the reforming part, and an outlet end of the second circulation line may be connected to the second pure water supply line.

According to the exemplary embodiment of the present disclosure, the hydrogen reforming system may include: a second adjustment valve provided in the second circulation line and configured to selectively adjust a flow of the source gas moving along the second circulation line.

According to the exemplary embodiment of the present disclosure, the hydrogen reforming system may include: a temperature measurement part provided in the source gas supply line and configured to measure temperatures of the source gas and the pure water to be introduced into the reforming part, in which the second adjustment valve selectively adjusts the flow of the source gas, which moves along the second circulation line, on the basis of a signal measured by the temperature measurement part.

### BRIEF DESCRIPTION OF THE FIGURES

FIG. 1 is a view of a hydrogen reforming system, according to an embodiment of the present disclosure.

FIG. 2 is a view of a movement route of pure water in the hydrogen reforming system of FIG. 1, according to an embodiment of the present disclosure.

FIG. 3 is a view of a modified example of a first circulation line in the hydrogen reforming system according to an embodiment of the present disclosure.

FIG. 4 is a view of the modified example of FIG. 3, according to an embodiment of the present disclosure.

FIG. 5 is a view of a temperature measurement part in the hydrogen reforming system of FIG. 3, according to an embodiment of the present disclosure.

FIG. 6 is a view of a second circulation line in the hydrogen reforming system, according to an embodiment of the present disclosure.

FIG. 7 is a view of the second circulation line of FIG. 6, according to an embodiment of the present disclosure.

FIG. 8 is structural diagram of one example hydrogen reforming system.

### DETAILED DESCRIPTION

The present disclosure describes a technology to uniformly maintain the temperatures of the source gas and the pure water to be introduced into the reformer of the hydrogen reforming system and ensure the stable operation of the reformer.

Hereinafter, exemplary embodiments of the present disclosure will be described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

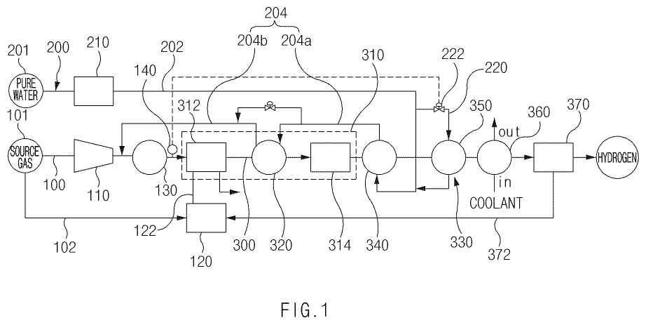

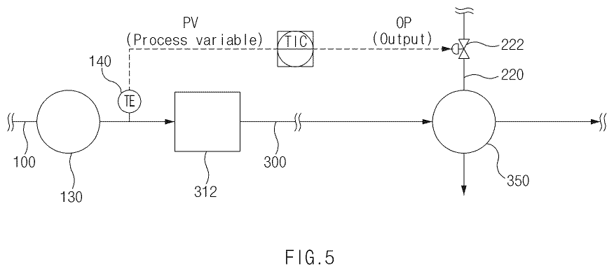

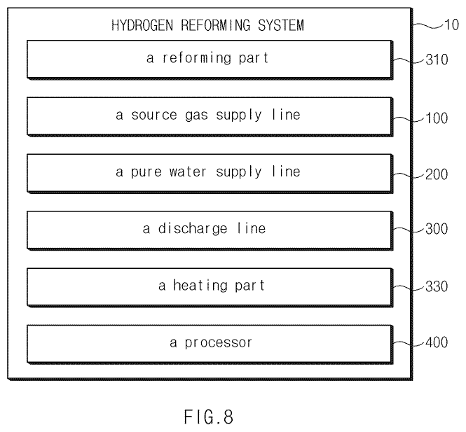

With reference to FIGS. 1 to 8, a hydrogen reforming system 10 according to an embodiment of the present disclosure includes a reforming part 310 configured to produce a reformed gas containing hydrogen by allowing a source gas and pure water to react with each other, a source gas supply line 100 connected to the reforming part 310 and configured to supply the source gas, a pure water supply line 200 connected to the source gas supply line 100 and configured to supply the pure water, a discharge line 300 configured to discharge the reformed gas from the reforming part 310, a heating part 330 configured to selectively heat any of the source gas and the pure water to be supplied to the reforming part 310 by using waste heat of the reformed gas discharged from the reforming part 310, and a processor 400 configured to control the temperature of the flame emitted from the heating part 330.

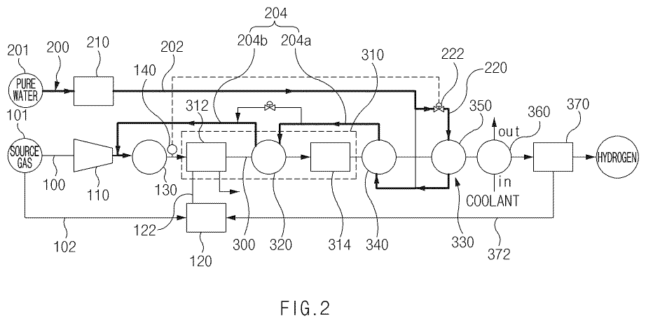

With reference to FIGS. 1 and 2, the reforming part 310 is configured to extract the reformed gas, which contains hydrogen, from the source gas.

For reference, in the embodiment of the present disclosure, the source gas may be understood as a raw material used to produce hydrogen.

Various gases (or liquids) from which hydrogen may be extracted may be used as the source gas. The present disclosure is not restricted or limited by the type and properties of the source gas.

For example, a town gas (e.g., LNG or LPG), which is supplied to general houses, may be used as the source gas. Hereinafter, an example will be described in which LNG is used as the source gas.

The reforming part 310 may have various structures capable of extracting hydrogen from the source gas based on steam reforming. The present disclosure is not restricted or limited by the type and structure of the reforming part 310.

According to the exemplary embodiment of the present disclosure, the reforming part 310 may include a reformer 312 configured to produce the reformed gas, which contains hydrogen, by allowing the source gas to react with the pure water (water), and a water gas shift reactor 314 configured to produce hydrogen by performing a reaction on carbon monoxide contained in the reformed gas discharged from the reformer 312.

The reformer 312 refers to a device for producing the reformed gas, which contains hydrogen, by allowing the source gas (e.g., LNG) to react with the water (endothermic reaction).

For example, a chemical reaction in the reformer 312 in which the endothermic reaction occurs may be expressed as Chemical Reaction Formula 1 below.

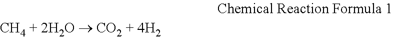

The reformer 312, which has a catalyst capable of producing the reformed gas by means of the endothermic reaction, may be used as the reformer 312. The present disclosure is not restricted or limited by the type and properties of the catalyst applied to the reformer 312.

The water gas shift reactor 314 is configured to additionally produce hydrogen by performing a reaction (exothermic reaction) on carbon monoxide contained in the reformed gas discharged from the reformer 312.

For example, a chemical reaction in the water gas shift reactor 314 in which the exothermic reaction occurs may be expressed as Chemical Reaction Formula 2 below.

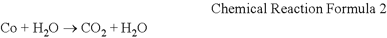

Various water gas shift reactors 314 capable of producing hydrogen on the basis of a denaturation reaction (water gas shift (WGS)) process on carbon monoxide may be used as the water gas shift reactor 314. The present disclosure is not restricted or limited by the type and properties of the water gas shift reactor 314.

With reference to FIGS. 1 and 2, the source gas supply line 100 is configured to supply the source gas (e.g., LNG) to the reforming part 310 (reformer).

The source gas supply line 100 may have various structures capable of supplying the source gas to the reforming part 310. The present disclosure is not restricted or limited by the structure of the source gas supply line 100.

For example, the source gas supply line 100 may be defined as having an approximately straight shape. The source gas stored in a source gas storage part 101 may be supplied to the reformer 312 along the source gas supply line 100.

In addition, various accessory devices may be provided in the source gas supply line 100 and may include a compressor 110 configured to compress the source gas moving along the source gas supply line 100, and a desulfurizer configured to refine sulfur compounds contained in the source gas. The present disclosure is not restricted or limited by the types and number of accessory devices provided in the source gas supply line 100.

With reference to FIGS. 1 and 2, the pure water supply line 200 may be connected to the source gas supply line 100 to supply the pure water (water) to the reforming part 310 (reformer).

The pure water supply line 200 may have various structures capable of supplying the pure water to the reforming part 310. The present disclosure is not restricted or limited by the structure of the pure water supply line 200.

For example, the pure water supply line 200 may be defined as having an approximately straight shape. The pure water stored in a pure water storage part 201 may be moved along the pure water supply line 200 and then supplied to the reformer 312 through the source gas supply line 100.

For example, an outlet end of the pure water supply line 200 may be connected to the source gas supply line 100 at a downstream side of the compressor 110 (e.g., between the compressor and a fourth heat exchanger).

According to the exemplary embodiment of the present disclosure, the pure water supply line 200 may include a first pure water supply line 202 having one end (inlet end) connected to a pure water supply part, and the second end (outlet end) connected to a second heat exchanger 340 to be described below, and a second pure water supply line 204 having one end (inlet end) connected to the second heat exchanger 340, and the second end (outlet end) connected to the source gas supply line 100 at an upstream side of the reforming part 310.

Hereinafter, an example will be described in which the second pure water supply line 204 includes a second-first pure water supply line 204a configured to connect the second heat exchanger 340 and a third heat exchanger 320 to be described below, and a second-second pure water supply line 204b configured to connect the third heat exchanger 320 and the source gas supply line 100.

In addition, the second pure water supply line 204 may include a bypass line having one end connected to the second-first pure water supply line 204a, and the second end connected to the second-second pure water supply line 204b. A part of the pure water supplied to the second-first pure water supply line 204a may flow directly to the second-second pure water supply line 204b without passing through the third heat exchanger 320.

In addition, various accessory devices may be provided in the pure water supply line 200 and include a filter, or a pump 210 configured to pump the pure water moving along the pure water supply line 200. The present disclosure is not restricted or limited by the types and number of accessory devices provided in the pure water supply line 200.

According to the exemplary embodiment of the present disclosure, the hydrogen reforming system 10 may include the third heat exchanger 320 provided in the discharge line 300 to pass through the second pure water supply line 204 and allow the reformed gas, which passes through the reforming part 310, and the pure water, which moves along the second pure water supply line 204, to exchange heat with each other.

The third heat exchanger 320 may have various structures capable of heating the pure water, which moves along the second pure water supply line 204, by using waste heat of the reformed gas discharged from the reformer 312. The present disclosure is not restricted or limited by the type and structure of the third heat exchanger 320.

In this case, the configuration in which the third heat exchanger 320 passes through the second pure water supply line 204 may be defined as including both a configuration in which the second pure water supply line 204 is in contact with the third heat exchanger 320 to exchange heat with the third heat exchanger 320, and a configuration in which the second pure water supply line 204 passes through the third heat exchanger 320 to exchange heat with the third heat exchanger 320.

According to the exemplary embodiment of the present disclosure, the hydrogen reforming system 10 may include a fourth heat exchanger 130 configured to heat the source gas and the pure water to be supplied to the reformer 312 through the source gas supply line 100.

The fourth heat exchanger 130 may have various structures capable of heating the source gas and the pure water, which are to be supplied to the reformer 312 through the source gas supply line 100, to a preset target temperature (e.g., 500° C. or higher). The present disclosure is not restricted or limited by the type and structure of the fourth heat exchanger 130.

For example, the fourth heat exchanger 130 may be configured to heat the source gas and the pure water by using heat of an exhaust gas generated by combustion in a burner 120.

According to the exemplary embodiment of the present disclosure, the hydrogen reforming system 10 may include an exhaust gas line 122 along which the exhaust gas heated by the burner 120 moves. The fourth heat exchanger 130 may be provided in the source gas supply line 100 configured to allow the pure water and the source gas moving along the source gas supply line 100 to exchange heat with the exhaust gas.

The exhaust gas line 122 may be passed through the reformer 312,

The high-temperature exhaust gas generated in the burner 120 may transfer heat to the reformer 312 of the reforming part 310 and be discharged.

The burner 120 may have various structures capable of discharging the high-temperature exhaust gas. The present disclosure is not restricted or limited by the type and structure of the burner 120.

According to the exemplary embodiment of the present disclosure, the hydrogen reforming system 10 may include a fuel line 102 configured to supply a part of the source gas, which is supplied along the source gas supply line 100, to the burner 120, and an off-gas supply line 372 configured to supply an off-gas, which is separated by a pressure swing adsorption part 370 to be described below (a separated gas remaining after hydrogen is separated from the reformed gas), to the burner 120. The burner 120 may be configured to generate heat by combusting the source gas, which is supplied along the fuel line 102, and the off-gas supplied along the off-gas supply line 372.

As described above, in the embodiment of the present disclosure, the off-gas separated by the pressure swing adsorption part 370 is used as the fuel for the burner 120. Therefore, it is possible to obtain an advantageous effect of improving energy efficiency and reducing production costs.

With reference to FIGS. 1 and 2, the discharge line 300 is configured to discharge the reformed gas produced by the reforming part 310.

The discharge line 300 may have various structures capable of guiding the reformed gas discharged from the denaturing part. The present disclosure is not restricted or limited by the structure of the discharge line 300.

In one example, the discharge line 300 may be defined as having an approximately straight shape. The reformed gas discharged from the denaturing part may be discharged along the discharge line 300.

The pressure swing adsorption (PSA) part 370 may be provided in the discharge line 300 and separate hydrogen from the reformed gas discharged from the reforming part 310 (denaturing part).

The pressure swing adsorption part 370 is configured to separate hydrogen from the reformed gas discharged from the reforming part 310 (denaturing part).

Various separation facilities capable of separating hydrogen from the reformed gas by means of pressure swing adsorption may be used as the pressure swing adsorption part 370. The present disclosure is not restricted or limited by the type and treatment method of the pressure swing adsorption part 370.

For example, the pressure swing adsorption part 370 may separate hydrogen from the reformed gas on the basis of low-temperature distillation, membrane separation, adsorption, and the like.

According to the exemplary embodiment of the present disclosure, the hydrogen reforming system 10 may include the second heat exchanger 340 provided in the discharge line 300 to pass through the pure water supply line 200 and allow the reformed gas, which passes through the reforming part 310, and the pure water, which moves along the pure water supply line 200, to exchange heat with each other.

The second heat exchanger 340 may have various structures capable of heating the pure water, which moves along the pure water supply line 200, by using waste heat of the reformed gas discharged from the reforming part 310 (denaturing part). The present disclosure is not restricted or limited by the type and structure of the second heat exchanger 340.

In this case, the configuration in which the second heat exchanger 340 passes through the pure water supply line 200 may be defined as including both a configuration in which the pure water supply line 200 is in contact with the second heat exchanger 340 to exchange heat with the second heat exchanger 340 and a configuration in which the pure water supply line 200 passes through the second heat exchanger 340 to exchange heat with the second heat exchanger 340.

For example, the reformed gas discharged from the reforming part 310 (denaturing part) may have a temperature of about 150 to 160° C., and the pure water having passed through the second heat exchanger 340 may be heated into a partial vapor state (e.g., 150 to 160° C.).

In addition, a fifth heat exchanger 360 may be provided in the discharge line 300 and cool the reformed gas to a preset reference temperature before the reformed gas is introduced into the pressure swing adsorption part 370.

The fifth heat exchanger 360 may have various structures capable of cooling the reformed gas, which is to be supplied to the pressure swing adsorption part 370, to a preset reference temperature. The present disclosure is not restricted or limited by the type and structure of the fifth heat exchanger 360.

For example, the fifth heat exchanger 360 may be provided in the discharge line 300 while passing through a coolant guide line. The fifth heat exchanger 360 may be configured to allow a coolant (e.g., water), which is supplied along the coolant guide line (not illustrated), and the reformed gas, which moves along the discharge line 300, to exchange heat with each other.

For example, the reformed gas discharged from the reforming part 310 (denaturing part) may have a temperature of about 150° C. to 160° C. A temperature of the reformed gas having passed through the fifth heat exchanger 360 may be about 40° C.

With reference to FIGS. 1 and 2, the heating part 330 is configured to selectively heat at least any one of the source gas and the pure water, which are to be supplied to the reforming part 310, by using waste heat of the reformed gas discharged from the reforming part 310.

In this case, the waste heat of the reformed gas may be defined as heat contained in the reformed gas discharged from the reforming part 310 (e.g., denaturing part). For example, the reformed gas discharged from the reforming part 310 (denaturing part) may have a temperature of about 150° C. to 160° C. The heating part 330 may selectively heat at least any one of the source gas and the pure water, which are to be supplied to the reforming part 310, by using heat of the reformed gas.

According to the exemplary embodiment of the present disclosure, the heating part 330 may include a first circulation line 220 having one end (inlet end) connected to a first point on the pure water supply line 200, and the second end (outlet end) connected to a second point on the pure water supply line 200 spaced apart from the first point, the first circulation line 220 being configured to circulate the pure water, which has flowed from the pure water supply line 200, back to the pure water supply line 200, and a first heat exchanger 350 provided in the first circulation line 220 while passing through the discharge line 300 and configured to allow the reformed gas, which is discharged from the reforming part 310, and the pure water, which moves along the first circulation line 220, to exchange heat with each other.

The processor 400 may be configured to increase the internal temperature of the reforming part 310 by increasing, based on control the temperature of the flame emitted from the heating part 330,

The first circulation line 220 is connected to the pure water supply line 200 and configured to circulate the pure water, which has flowed from the pure water supply line 200, back to the pure water supply line 200.

That is, a part of the pure water, which moves along the pure water supply line 200, may flow along the first circulation line 220 and then circulate back to the pure water supply line 200 through the first circulation line 220.

The first circulation line 220 may have various structures capable of circulating the pure water, which has flowed from the pure water supply line 200, back to the pure water supply line 200. The present disclosure is not restricted or limited by the structure and shape of the first circulation line 220.

Hereinafter, an example will be described in which the first circulation line 220 is configured to have an approximately quadrangular loop shape. According to another embodiment of the present disclosure, the first circulation line 220 may be configured to have a curved loop shape or other shapes.

According to the exemplary embodiment of the present disclosure, the second point may be defined at a downstream side of the first point along the pure water supply line 200 (e.g., defined between the first point and the second heat exchanger). According to another embodiment of the present disclosure, the second point may be defined at an upstream side of the first point along the pure water supply line 200 (e.g., defined between the first point and the pump).

Hereinafter, an example will be described in which a first end and a second end of the first circulation line 220 are connected to the first pure water supply line 202.

The first heat exchanger 350 is provided in the first circulation line 220 while passing through the discharge line 300 and configured to allow the reformed gas, which is discharged from the reforming part 310, and the pure water, which moves along the first circulation line 220, to exchange heat with each other.

The first heat exchanger 350 may have various structures capable of heating the pure water, which moves along the first circulation line 220, by using waste heat of the reformed gas discharged from the reforming part 310 (e.g., the denaturing part). The present disclosure is not restricted or limited by the type and structure of the first heat exchanger 350.

In this case, the configuration in which the first heat exchanger 350 passes through the discharge line 300 may be defined as including both a configuration in which the discharge line 300 is in contact with the first heat exchanger 350 to exchange heat with the first heat exchanger 350 and a configuration in which the discharge line 300 passes through the first heat exchanger 350 to exchange heat with the first heat exchanger 350.

For example, the reformed gas discharged from the reforming part 310 (denaturing part) may have a temperature of about 150° C. to 160° C. A temperature of the pure water having passed through the first heat exchanger 350 may be about 100° C. to 150° C.

With reference to FIGS. 1 to 5, according to the exemplary embodiment of the present disclosure, the hydrogen reforming system 10 may include a first adjustment valve 222 provided in the first circulation line 220 and configured to selectively adjust a flow of the pure water moving along the first circulation line 220.

In this case, the configuration in which the flow of the pure water moving along the first circulation line 220 is adjusted may be defined as including both a configuration in which the flow of the pure water moving along the first circulation line 220 is regulated (turned on or off) and a configuration in which a flow rate of the pure water moving along the first circulation line 220 is adjusted.

For example, the adjustment of the flow rate of the pure water moving along the first circulation line 220 may be performed by changing a cross-sectional area of an inlet port of the first adjustment valve 222 (an area through which the pure water passes).

Various valves capable of selectively adjusting the flow of the pure water moving along the first circulation line 220 may be used as the first adjustment valve 222. The present disclosure is not restricted or limited by the type and structure of the first adjustment valve 222. For example, a typical solenoid valve may be used as the first adjustment valve 222.

According to the exemplary embodiment of the present disclosure, the hydrogen reforming system 10 may include a temperature measurement part 140 provided in the source gas supply line 100 and configured to measure temperatures of the source gas and the pure water to be introduced into the reforming part 310. The first adjustment valve 222 may selectively adjust the flow of the pure water, which moves along the first circulation line 220, on the basis of a signal measured by the temperature measurement part 140.

For example, when the temperatures of the source gas and the pure water, which are measured by the temperature measurement part 140, are higher than a preset reference temperature, the first adjustment valve 222 may block the flow of the pure water moving along the first circulation line 220 or reduce (e.g., gradually reduce) the flow rate of the pure water moving along the first circulation line 220.

On the contrary, when the temperatures of the source gas and the pure water, which are measured by the temperature measurement part 140, are lower than the preset reference temperature, the first adjustment valve 222 may increase the flow rate of the pure water moving along the first circulation line 220.

The temperature measurement part 140 may be provided at various points on the source gas supply line 100 in accordance with required conditions and design specifications.

In particular, the temperature measurement part 140 may be provided in the source gas supply line 100 so as to be positioned between the fourth heat exchanger 130 and the reformer 312 in order to more accurately measure a temperature of an inlet part of the reformer 312 (the temperatures of the source gas and the pure water to be introduced into the reformer 312).

A typical temperature sensor capable of measuring the temperatures of the pure water and the source gas moving along the source gas supply line 100 may be used as the temperature measurement part 140. The present disclosure is not restricted or limited by the type and structure of the temperature measurement part 140.

As described above, in the embodiment of the present disclosure, the pure water, which is to be supplied to the reformer 312, is heated by waste heat of the reformed gas discharged from the denaturing part, such that the temperatures of the source gas and the pure water to be introduced into the reformer 312 may be constantly maintained regardless of a change in temperature of the pure water, which is to be supplied, caused by a change in the external environment. Therefore, it is possible to obtain an advantageous effect of minimizing the occurrence of coke in the reformer 312 and stably ensuring reaction efficiency of the reforming part 310.

Moreover, in the embodiment of the present disclosure, the pure water is heated by waste heat of the reformed gas to a temperature appropriate for a reaction without additionally providing a separate heat source for heating the source gas or the pure water to be introduced into the reformer 312. Therefore, it is possible to obtain an advantageous effect of simplifying a structure, improving a degree of design freedom and spatial utilization, minimizing electric power consumption, and improving energy efficiency.

Meanwhile, in the embodiment of the present disclosure illustrated and described above, the example has been described in which the pure water, which has flowed from the first pure water supply line 202 to the first circulation line 220, circulates back to the first pure water supply line 202. However, according to another embodiment of the present disclosure, the pure water, which has flowed from the first pure water supply line 202 to a first circulation line 220′, may circulate to the second pure water supply line 204.

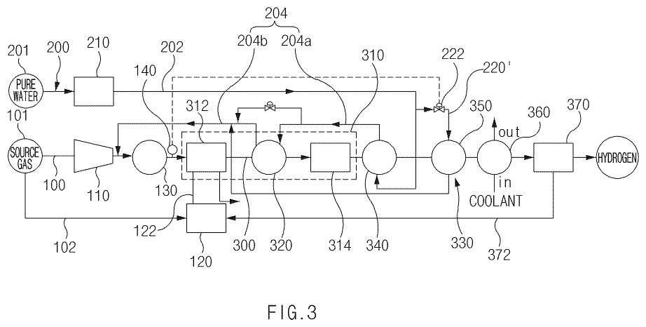

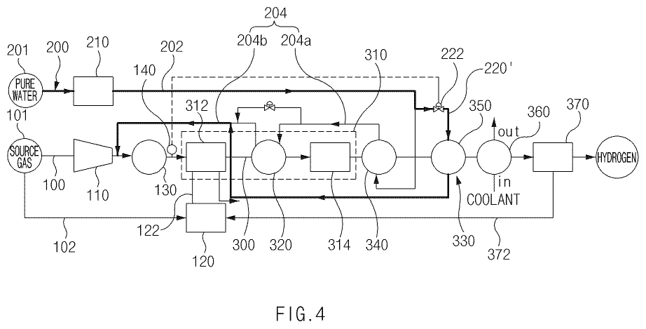

With reference to FIGS. 3 and 4, according to the exemplary embodiment of the present disclosure, a first end (inlet end) of the first circulation line 220′ may be connected to the first pure water supply line 202, and a second end (outlet end) of the first circulation line 220 may be connected to the second pure water supply line 204.

In particular, the second end of the first circulation line 220′ may be connected to the second pure water supply line 204 at a downstream side of the third heat exchanger 320.

As described above, in the embodiment of the present disclosure, the pure water heated by the first heat exchanger 350 is introduced into the second pure water supply line 204 adjacent to the reformer 312, such that a change in temperature of the pure water to be introduced into the reformer 312 (a change in temperature occurring while the pure water moves along the first circulation line) may be excluded. Therefore, it is possible to obtain an advantageous effect of more constantly maintaining the temperatures of the source gas and the pure water to be introduced into the reformer 312.

In addition, in the embodiment of the present disclosure illustrated and described above, the example has been described in which the pure water having passed through the first heat exchanger 350 (the pure water heated by waste heat of the reformed gas) is supplied to the reformer 312 through the pure water supply line 200 and the source gas supply line 100. However, according to another embodiment of the present disclosure, the pure water having passed through the first heat exchanger 350 may be supplied directly to the reformer 312.

In the embodiment of the present disclosure illustrated and described above, the example has been described in which the pure water to be supplied to the reforming part 310 is heated by waste heat of the reformed gas. However, according to another embodiment of the present disclosure, the source gas to be supplied to the reforming part 310 may also be heated by waste heat of the reformed gas.

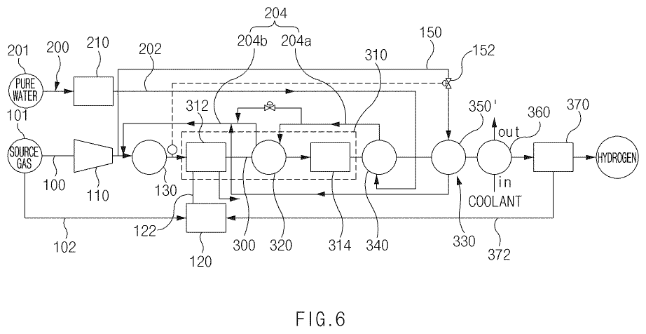

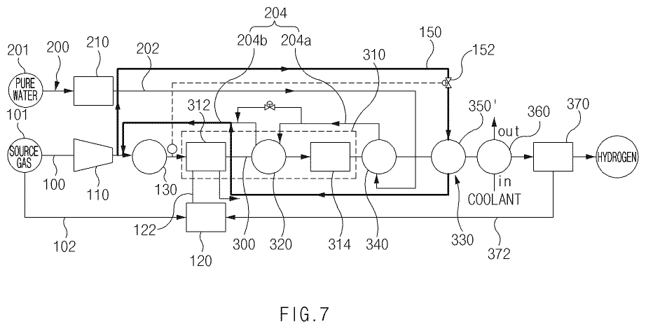

With reference to FIGS. 6 and 7, the hydrogen reforming system 10 according to the embodiment of the present disclosure may include the reforming part 310 configured to produce the reformed gas containing hydrogen by allowing the source gas and the pure water to react with each other, the source gas supply line 100 connected to the reforming part 310 and configured to supply the source gas, the pure water supply line 200 connected to the source gas supply line 100 and configured to supply the pure water, the discharge line 300 configured to discharge the reformed gas from the reforming part 310, and the heating part 330 configured to selectively heat at least any one of the source gas and the pure water, which are to be supplied to the reforming part 310, by using waste heat of the reformed gas discharged from the reforming part 310. The heating part 330 may include a second circulation line 150 connected to the source gas supply line 100 and configured to circulate the source gas, which has flowed from the source gas supply line 100, back to the source gas supply line 100, and the first heat exchanger 350 provided in the second circulation line 150 while passing through the discharge line 300 and configured to allow the reformed gas, which has passed through the reforming part 310, and the source gas, which moves along the second circulation line 150, to exchange heat with each other.

The second circulation line 150 is connected to the source gas supply line 100 and configured to circulate the source gas, which has flowed from the source gas supply line 100, back to the source gas supply line 100.

That is, a part of the source gas, which moves along the source gas supply line 100, may flow along the second circulation line 150 and then circulate back to the source gas supply line 100 through the second circulation line 150.

The second circulation line 150 may have various structures capable of circulating the source gas, which has flowed from the source gas supply line 100, back to the source gas supply line 100. The present disclosure is not restricted or limited by the structure and shape of the second circulation line 150.

Hereinafter, an example will be described in which the second circulation line 150 is configured to have an approximately quadrangular loop shape. According to another embodiment of the present disclosure, the second circulation line 150 may be configured to have a curved loop shape or other shapes.

According to the exemplary embodiment of the present disclosure, the pure water supply line 200 may include the first pure water supply line 202 having one end connected to the pure water supply part, and the second end connected to the second heat exchanger 340, and the second pure water supply line 204 having one end connected to the second heat exchanger 340, and the second end connected to the source gas supply line 100 at an upstream side of the reforming part 310. An outlet end of the second circulation line 150 may be connected to the second pure water supply line 204.

In the embodiment illustrated and described above, the example has been described in which the source gas having flowed to the second circulation line 150 passes through the second pure water supply line 204 and circulates to the source gas supply line 100. However, according to another embodiment of the present disclosure, the outlet end of the second circulation line 150 may be connected directly to the source gas supply line 100, or the outlet end of the second circulation line 150 may be connected to the reformer 312.

In addition, according to another embodiment of the present disclosure, the outlet end of the second circulation line 150 may be connected to the first pure water supply line 202. However, when the outlet end of the second circulation line 150 is connected to the first pure water supply line 202, the source gas, which has a composition different from that of the pure water, passes through the second heat exchanger 340. For this reason, the heat exchange performance of the second heat exchanger 340 may deteriorate, and the flow rate of the pure water to be supplied to the reformer 312 may vary. Therefore, the outlet end of the second circulation line 150 may be connected to the second pure water supply line 204 at the downstream side of the third heat exchanger 320.

The first heat exchanger 350 may be provided in the second circulation line 150 while passing through the discharge line 300 and configured to allow the reformed gas, which is discharged from the reforming part 310, and the source gas, which moves along the second circulation line 150, to exchange heat with each other.

The first heat exchanger 350 may have various structures capable of heating the source gas, which moves along the second circulation line 150, by using waste heat of the reformed gas discharged from the reforming part 310 (e.g., the denaturing part). The present disclosure is not restricted or limited by the type and structure of the first heat exchanger 350.

In this case, the configuration in which the first heat exchanger 350 passes through the discharge line 300 may be defined as including both a configuration in which the discharge line 300 is in contact with the first heat exchanger 350 to exchange heat with the first heat exchanger 350 and a configuration in which the discharge line 300 passes through the first heat exchanger 350 to exchange heat with the first heat exchanger 350.

For example, the reformed gas discharged from the reforming part 310 (denaturing part) may have a temperature of about 150° C. to 160° C. A temperature of the source gas having passed through the first heat exchanger 350 may be about 100° C. to 150° C.

With reference to FIGS. 6 to 7, according to the exemplary embodiment of the present disclosure, the hydrogen reforming system 10 may include a second adjustment valve 152 provided in the second circulation line 150 and configured to selectively adjust the flow of the source gas moving along the second circulation line 150.

In this case, the configuration in which the flow of the source gas moving along the second circulation line 150 is adjusted may be defined as including both a configuration in which the flow of the source gas moving along the second circulation line 150 is regulated (turned on or off) and a configuration in which a flow rate of the source gas moving along the second circulation line 150 is adjusted.

For example, the adjustment of the flow rate of the source gas moving along the second circulation line 150 may be performed by changing a cross-sectional area of an inlet port of the second adjustment valve 152 (an area through which the source gas passes).

Various valves capable of selectively adjusting the flow of the source gas moving along the second circulation line 150 may be used as the second adjustment valve 152. The present disclosure is not restricted or limited by the type and structure of the second adjustment valve 152. For example, a typical solenoid valve may be used as the second adjustment valve 152.

According to the exemplary embodiment of the present disclosure, the hydrogen reforming system 10 may include the temperature measurement part 140 provided in the source gas supply line 100 and configured to measure the temperatures of the source gas and the pure water to be introduced into the reforming part 310. The second adjustment valve 152 may selectively adjust the flow of the source gas, which moves along the second circulation line 150, on the basis of a signal measured by the temperature measurement part 140.

For example, when the temperatures of the source gas and the pure water, which are measured by the temperature measurement part 140, are higher than a preset reference temperature, the second adjustment valve 152 may block the flow of the source gas moving along the second circulation line 150 or reduce (e.g., gradually reduce) the flow rate of the source gas moving along the second circulation line 150.

On the contrary, when the temperatures of the source gas and the pure water, which are measured by the temperature measurement part 140, are lower than the preset reference temperature, the second adjustment valve 152 may increase the flow rate of the source gas moving along the second circulation line 150.

The temperature measurement part 140 may be provided at various points on the source gas supply line 100 in accordance with required conditions and design specifications.

In particular, the temperature measurement part 140 may be provided in the source gas supply line 100 so as to be positioned between the fourth heat exchanger 130 and the reformer 312 in order to more accurately measure a temperature of the inlet part of the reformer 312 (the temperatures of the source gas and the pure water to be introduced into the reformer).

A typical temperature sensor capable of measuring the temperatures of the pure water and the source gas moving along the source gas supply line 100 may be used as the temperature measurement part 140. The present disclosure is not restricted or limited by the type and structure of the temperature measurement part 140.

According to the embodiment of the present disclosure described above, it is possible to obtain an advantageous effect of improving stability, reliability, and reforming efficiency.

In particular, according to the embodiment of the present disclosure, it is possible to obtain an advantageous effect of uniformly maintaining the temperatures of the source gas and the pure water to be introduced into the reformer and ensuring the stable operation of the reformer.

Among other things, according to the embodiment of the present disclosure, it is possible to obtain an advantageous effect of minimizing a drop in temperature of the source gas or the pure water to be introduced into the reformer (minimizing the occurrence of coke in the reformer) by using waste heat of the reformed gas discharged from the reforming part, and an advantageous effect of stably ensuring the reaction efficiency of the reformer.

In addition, according to the embodiment of the present disclosure, it is possible to obtain an advantageous effect of minimizing electric power consumption and improving energy efficiency.

In addition, according to the embodiment of the present disclosure, it is possible to obtain an advantageous effect of simplifying the structure and improving the degree of design freedom and spatial utilization.

While the embodiments have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

1. A hydrogen reforming system comprising:
a reforming part configured to produce a reformed gas containing hydrogen by allowing a source gas and pure water to react with each other;
a source gas supply line connected to the reforming part and configured to supply the source gas;
a pure water supply line connected to the source gas supply line and configured to supply the pure water;
a discharge line configured to discharge the reformed gas from the reforming part;
a heating part configured to selectively heat any of the source gas and the pure water, which are to be supplied to the reforming part, by using waste heat of the reformed gas discharged from the reforming part, and
a processor configured to control the temperature of the flame emitted from the heating part.

2. The hydrogen reforming system of claim 1, wherein the reforming part comprises:
a reformer configured to produce the reformed gas containing hydrogen by allowing the source gas and the pure water to react with each other; and
a water gas shift reactor configured to produce hydrogen by performing a reaction on carbon monoxide contained in the reformed gas discharged from the reformer.

3. The hydrogen reforming system of claim 1, wherein the heating part comprises:
a first circulation line having a first end connected to a first point on the pure water supply line, and a second end connected to a second point on the pure water supply line spaced apart from the first point, the first circulation line being configured to circulate the pure water, which has flowed from the pure water supply line, back to the pure water supply line; and
a first heat exchanger provided in the first circulation line while passing through the discharge line and configured to allow the reformed gas, which is discharged from the reforming part, and the pure water, which moves along the first circulation line, to exchange heat with each other.

4. The hydrogen reforming system of claim 3, wherein the second point is defined at a downstream side of the first point along the pure water supply line.

5. The hydrogen reforming system of claim 3, comprising:
a second heat exchanger provided in the discharge line while passing through the pure water supply line and configured to allow the reformed gas, which has passed through the reforming part, and the pure water, which moves along the pure water supply line, to exchange heat with each other.

6. The hydrogen reforming system of claim 5, wherein the pure water supply line comprises:
a first pure water supply line having a first end connected to a pure water supply part, and a second end connected to the second heat exchanger; and
a second pure water supply line having one end connected to the second heat exchanger, and the second end connected to the source gas supply line at an upstream side of the reforming part.

7. The hydrogen reforming system of claim 6, wherein the first end and the second end of the first circulation line are connected to the first pure water supply line.

8. The hydrogen reforming system of claim 6, wherein the first end of the first circulation line is connected to the first pure water supply line, and the second end of the first circulation line is connected to the second pure water supply line.

9. The hydrogen reforming system of claim 8, comprising:
a third heat exchanger provided in the discharge line while passing through the second pure water supply line and configured to allow the reformed gas, which passes through the reforming part, and the pure water, which moves along the second pure water supply line, to exchange heat with each other.

10. The hydrogen reforming system of claim 9, wherein the second end of the first circulation line is connected to the second pure water supply line at a downstream side of the third heat exchanger.

11. The hydrogen reforming system of claim 3, comprising:
a first adjustment valve provided in the first circulation line and configured to selectively adjust a flow of the pure water moving along the first circulation line.

12. The hydrogen reforming system of claim 11, comprising:
a temperature measurement part provided in the source gas supply line and configured to measure temperatures of the source gas and the pure water to be introduced into the reforming part,
wherein the first adjustment valve selectively adjusts the flow of the pure water, which moves along the first circulation line, on the basis of a signal measured by the temperature measurement part.

13. The hydrogen reforming system of claim 1, wherein the heating part comprises:
a second circulation line connected to the source gas supply line and configured to circulate the source gas, which has flowed from the source gas supply line, back to the source gas supply line; and
a first heat exchanger provided in the second circulation line while passing through the discharge line and configured to allow the reformed gas, which has passed through the reforming part, and the source gas, which moves along the second circulation line, to exchange heat with each other.

14. The hydrogen reforming system of claim 13, comprising:
a second heat exchanger provided in the discharge line while passing through the pure water supply line and configured to allow the reformed gas, after passing through the reforming part, and the pure water, which moves along the pure water supply line, to exchange heat with each other.

15. The hydrogen reforming system of claim 14, wherein the pure water supply line comprises:
a first pure water supply line having a first end connected to a pure water supply part, and a second end connected to the second heat exchanger; and
a second pure water supply line having a first end connected to the second heat exchanger, and a second end connected to the source gas supply line at an upstream side of the reforming part, and
wherein an outlet end of the second circulation line is connected to the second pure water supply line.

16. The hydrogen reforming system of claim 13, comprising:
a second adjustment valve provided in the second circulation line and configured to selectively adjust a flow of the source gas moving along the second circulation line.

17. The hydrogen reforming system of claim 16, comprising:
a temperature measurement part provided in the source gas supply line and configured to measure temperatures of the source gas and the pure water to be introduced into the reforming part,
wherein the second adjustment valve selectively adjusts the flow of the source gas, which moves along the second circulation line, on the basis of a signal measured by the temperature measurement part.

18. The hydrogen reforming system of claim 1, comprising:
an exhaust gas line along which exhaust gas heated by a burner moves to the reformer; and
a fourth heat exchanger provided in the source gas supply line configured to heat the source gas and the pure water to be supplied the reformer through the source gas.

19. The hydrogen reforming system of claim 18, comprising:
a pressure swing adsorption part provided in the discharge line and configured to separate hydrogen from the reformed gas discharged from the reforming part; and
an off-gas supply line configured to connect the pressure swing adsorption part and the burner and supply an off-gas, which remains after hydrogen is separated from the reformed gas, to the burner.

20. The hydrogen reforming system of claim 16, wherein the adjustment of the flow of the source gas moving along the second circulation line is performed by changing a cross-sectional area of an inlet port of the second adjustment valve.
